(19) United States
(12) Patent Application Publication
(10) Pub. No.: US 2014/0114877 A1
(43) Pub. Date: Apr. 24, 2014

(54) SYSTEMS AND METHODS FOR AUTHENTICATING ONLINE CUSTOMER SERVICE REVIEWS

(71) Applicant: ReviewBuzz Inc., Vista, CA (US)

(72) Inventor: Michael Montano, Vista, CA (US)

(73) Assignee: ReviewBuzz Inc., Vista, CA (US)

(21) Appl. No.: 14/061,746

(22) Filed: Oct. 23, 2013

Related U.S. Application Data
(60) Provisional application No. 61/717,548, filed on Oct. 23, 2012.
(60) Provisional application No. 61/717,549, filed on Oct. 23, 2012.
(60) Provisional application No. 61/717,550, filed on Oct. 23, 2012.
(60) Provisional application No. 61/717,551, filed on Oct. 23, 2012.

(51) Int. Cl. G06Q 30/02

(52) U.S. Cl. CPC G06Q 30/0282
USPC 705/347

(57) ABSTRACT

Systems and methods are provided for authenticating online customer service reviews using unique customer identifiers such as payment data and location data. A customer authentication process is performed before or after a customer who obtains a service from a particular employee of a service provider is asked to complete a review of the employee to verify that the customer completing the review is the customer that received the service from the employee. A payment-based authentication process will check the payment information to determine if the customer's payment information matches their customer review profile, while a location-based authentication process will determine whether the user's mobile device is in the location where the service was performed. Once the authentication process verifies that the customer creating the review, the resulting online customer service review can be identified as an authentic customer review of the service provider, employee and the service.

### BACKGROUND

1. Technical Field

The embodiments described herein are related to authenticating online customer service reviews, and more particularly to utilizing customer payment, location and other unique data to authenticate online customer service reviews of a service provider.

2. Related Art

Customer service reviews are an invaluable asset to any business which interacts with a customer. Whether the business is a direct service provider where customers are directly provided with a service by an employee (ex: plumber, phone company) or an indirect service provider where customers are provided with a product through the employee (ex: retail store or restaurant), the customer's experience with the employee often has a significant effect on the customer's desire to use that business in the future.

In order to ensure that employees are providing good customer service, businesses often request customer service reviews. Businesses may use the customer service reviews internally to evaluate their business practices, evaluate employees and generally improve the customer service experience. Some businesses will also publish the customer reviews for other customers to see as a marketing or advertising tool to demonstrate their ability to provide good customer service. More recently, online customer service reviews have become an industry unto themselves, with many third-party customer review companies being created where customers can post reviews of their customer service experiences. These companies will then post the customer reviews on a website so that potential customers can sort through reviews for multiple competing businesses and determine which company to do business with. Websites that provide business listings, such as search engines or shopping sites, will also integrate customer service reviews into their listings, so that customers searching for a local business can look for a nearby service or product while also reading the reviews of that business.

Despite the potential benefits, customer service reviews—especially online reviews—can be fraught with peril. The Internet is a haven of unfiltered content where people often make anonymous comments that they would never say in person, and where people make potentially libelous statements anonymously without regard to any potential consequences. For businesses which receive online customer service reviews, negative or false reviews can be devastating, as the reviews, even if untrue, are often prominently displayed and impossible to erase. More difficult is the fact that customers are much more likely to post negative reviews when they've had a bad experience than they are to post positive reviews when they've had a good experience.

### SUMMARY OF THE INVENTION

The embodiments described herein are directed to systems and methods for authenticating online customer service reviews using unique customer identifiers such as payment data and location data. A customer authentication process is performed before or after a customer who obtains a service from a particular employee of a service provider is asked to complete a review of the employee to verify that the customer completing the review is the customer that received the service from the employee. A payment-based authentication process will check the payment information to determine if the customer's payment information matches their customer review profile, while a location-based authentication process will determine whether the user's mobile device is in the location where the service was performed. Additional unique customer identifiers may also be utilized. Once the authentication process verifies that the customer creating the review, the resulting online customer service review can be identified as an authentic customer review of the service provider, employee and the service.

Additional aspects related to these embodiments will be set forth in part in the description which follows, and in part will be apparent from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system of authenticating online customer service reviews, according to one embodiment of the invention;

FIG. 2 illustrates a method of authenticating online customer service reviews, according to one embodiment of the invention;

FIG. 3 illustrates a system and method of requesting, receiving, organizing and broadcasting customer service reviews, according to one embodiment of the invention;

FIGS. 4A and 4B illustrate graphical user interfaces (GUIs) for managers and administrators to manage the reviews, according to one embodiment of the invention;

FIGS. 5A-5F illustrate GUIs of an employee review profile, according to one embodiment of the invention;

FIGS. 6A-6C illustrate GUIs of a business reviewing dashboard which displays summaries of review information, according to one embodiment of the invention; and

FIG. 7 illustrates a block diagram of an embodiment of a computer/server system upon which an embodiment of the inventive methodology may be implemented.

### DETAILED DESCRIPTION OF THE INVENTION

In the following detailed description, reference will be made to the accompanying drawings. The aforementioned accompanying drawings show by way of illustration and not by way of limitation, specific embodiments and implementations consistent with the principles of the present invention. These implementations are described in sufficient detail to enable those skilled in the art to practice the invention, and it is to be understood that other implementations may be utilized and that structural changes and/or substitutions of various elements may be made without departing from the scope and spirit of the invention. The following detailed description is, therefore, not to be construed in a limited sense. Additionally, the various embodiments of the invention as described may be implemented in the form of software running on a general purpose computer in the form of a specialized hardware, or combination of software and hardware.

The embodiments described herein provide for an Internet-based system for creating and authenticating customer service reviews of a service provider. The customer service reviews are authenticated by tying the review to at least one unique customer identifier that verifies that the customer creating the online customer service review is the same customer that received service from an employee of the service provider. The credibility of the customer service review is therefore significantly higher than a review posted by an anonymous reviewer, and malicious false negative reviews can be prevented by requiring authentication prior to a review being posted or removed if they cannot be authenticated after the fact.

In addition, simply tying the review process to the payment process will increase the convenience and timeliness of completing a review, which increases the likelihood of the customer completing the review and providing more accurate comments and remarks regarding their customer service experience.

Throughout the application, the term “review” will be used to encompass customer service reviews, recommendations, surveys, testimonials, customer satisfaction ratings, rankings, or any type of feedback provided by the customer with regard to service provided by an employee.

### System Overview

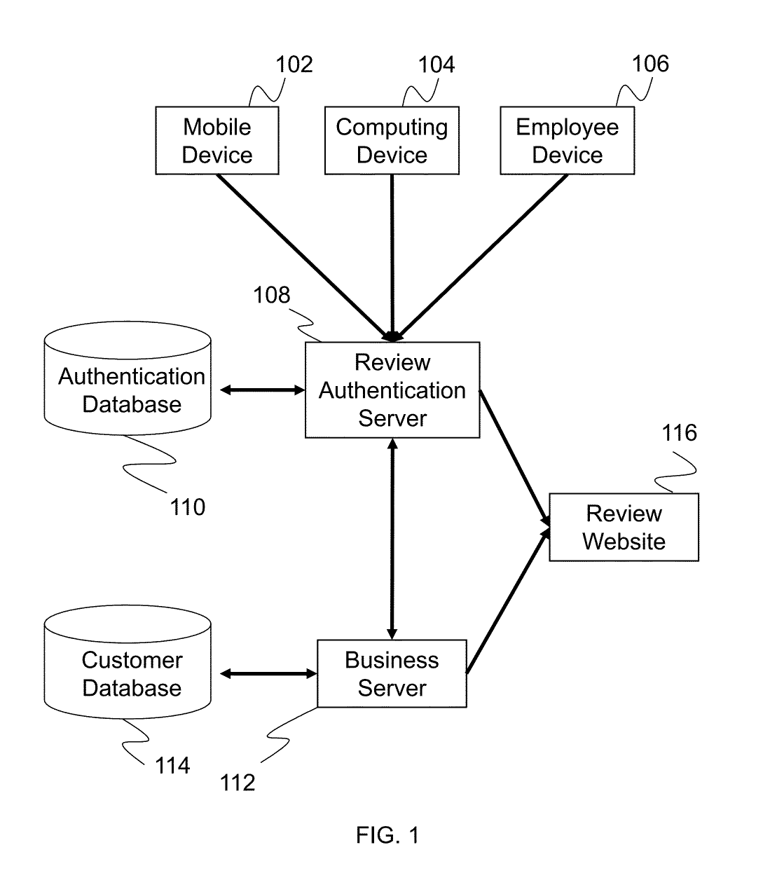

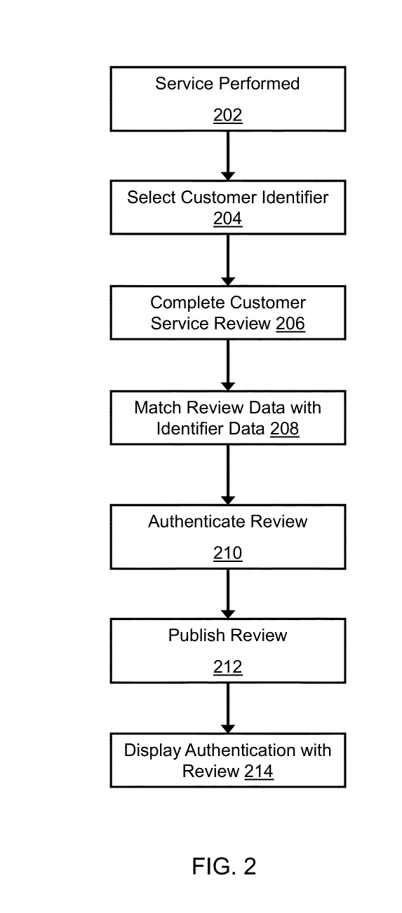

FIG. 1 and FIG. 2 illustrate one embodiment of a system and method, respectively, for authenticating online customer service reviews. When a service provider such as a business provides a service to a customer (step 202), a unique customer identifier is selected (step 204) which will be used to verify the identity of the customer who posts the online customer service review. Several different unique customer identifiers may be provided, such as a payment identifier which looks at the customer's payment information via a name on a credit card number, a name on an electronic payment (including a mobile payment) or a name on a check (which is deposited via a mobile deposit application). Other payment information that the customer provides when making a payment, such as a billing address, zip code, phone number, etc., may also be viewed to determine the identity of the customer.

Another type of unique customer identifier is a location-based identifier which uses location services on the customer's mobile device to determine if the customer is in the same location as the service that was performed, or if the customer is in the same vicinity as the mobile device of the employee that performed the service. In addition to location-based services, the employee could use their mobile device to interact with the customer's mobile device to verify their vicinity with each other and confirm that the customer is the person that the employee is interacting with. The mobile device interactions could be through any wired or wireless communication protocol, such as Bluetooth®, 802.11, near-field communications, RFID, etc. or through an optical recognition procedure such as having the customer take a picture of a QR code displayed on the employee's mobile device. The communication with the employee will also serve to confirm the employee's presence at the service appointment.

Additional options for unique customer identifiers include biometrics, gesture recognition or passcodes that the customer could passively transmit or manually enter in order to confirm their identity.

The type of customer identifier selected will determine which device is utilized to generate the unique identifier and transmit it for authentication. In FIG. 1, a mobile device 102 (such as a tablet, smartphone or laptop), a computing device 104 (such as a desktop computer or server) or an employee device 106 (such as a tablet, smartphone, laptop or other proprietary electronic device used by a service provider) may be utilized to determine the authenticity of the customer as well as complete the customer service review. For example, a customer using a smartphone may initiate a mobile payment to the service provider at the conclusion of the service using an application on the smartphone run by the service provider. Once the mobile payment has been made, the application will immediately prompt the customer to complete a customer service review of the employee and the service they just received. The request to complete the customer service review is therefore tied to the completion of the payment for the service and therefore operates to authenticate the customer who uses the application to post an online customer service review.

In another embodiment, upon completion of service, a computing device 104 such as a desktop computer may be utilized by the customer to post an online customer service review of the employee who performed the service. The customer may have been prompted to create a review by an email received at the computing device 104. When the customer is completing their review, location-based services may detect the customer's IP address and determine if the physical known address corresponding to the registered IP address matches the customer's address in the service provider's database. If the IP address is determined to match the address or general area, the review can be authenticated. Additionally, the customer may be provided with a business card from the employee which contains a unique code that is tied to the service appointment and the employee which the customer can then enter on a third-party reviewing website, the business website or on an application running on the computing device. Once the code is entered, the entry of the correct code operates to verify that the customer which created that customer service review was the same person that the employee handed the card to. The unique code may be generated for each appointment or could simply correspond to an invoice number on the service provider's invoice.

In an additional embodiment, the employee device 106 may be utilized to authenticate the customer service review by obtaining customer data directly from the customer at the service appointment. For example, if the customer provides a credit card for payment of the service invoice, the employee may run the credit card through a card reader device connected with the employee device or an optical card reading application integrated into the employee device which will then provide the employee device with the credit card information that can be used to match the name, address, phone number or other relevant information with the information about the customer posting the review.

While the step of authorizing the review is described herein as taking place each time a customer completes a review, another embodiment provides for a one-time authorization to occur when a customer registers with the system or a third-party review service. The customer may be asked to provide payment identification information such as a credit card number, or an email or text message may be sent to an address provided by the customer where the customer must then reply or click on a unique hyperlink in order to confirm their receipt of the message and thus their identity as tied with their account. In another embodiment, the authentication process may be completed at certain time intervals in order to verify that the customer still has control of their account.

In a further embodiment, the authentication may be tied to an electronic payment service such as an e-wallet service, where a payment made through the e-wallet will then prompt the customer for a review. Furthermore, an application or review service could be tied to the e-wallet or mobile payment account to provide automatic authentication of the customer based on the verification provided from the e-wallet or mobile payment account action or activity.

Once the mobile device 102, computing device 104 or employee device 106 select the customer identifier and obtain the customer identifier, the unique identifier is transmitted to the review authentication server 108. The customer service review may also be completed (step 206) at the mobile device 102, computing device 104 or employee device 106 and transmitted to the review authentication server prior to, simultaneously with or after the authentication of the customer has been completed. The review authentication server 108 will match the unique customer identifier with data stored in a connected authentication database 110 or request data needed to authenticate the customer from customer records stored in a customer database 114 of a business server 112 of the service provider/business (step 208). In one embodiment, the authentication server will compare the unique customer identifier with information from the customer service review itself, such as the name and location of the person identified as providing the review, the date the review was created, the name of the employee identified in the review, etc. More dynamic and complex comparisons could be made by looking for indications of an invoice total in the review which can be matched with the service provider's invoice, or looking for keywords in the review that match the description of the service provided on the business invoice about the service performed. If the customer identifier matches the information from the review, the customer service review can be authenticated (step 210).

Once the review has been authenticated, the review can be published (step 212) by transmitting the review to the business server 112 or a review website 116 operated by the business, a third party reviewing service or by the system's own review website or application running on a computing device such as a smartphone or tablet. In one example, the review maybe published to the employee's personal profile on a social media service where they advertise their services in addition to on the employer's website in order to further promote their service. The employee could then advertise their own customer service reviews with a card, email advertisement or online advertisement linking to their online review profile. The review may be displayed with an authentication indicator such as a keyword, logo or other symbol indicating that the review has been authenticated (step 214).

In addition to verifying reviews as they are completed, the system may also process already-completed reviews to authenticate the reviews after the fact. The post-review authentication may be completed through similar processes described above of identifying unique customer identifiers in the review (name of reviewer, date of review, name of employee mentioned in the review) that can be matched with business records in the customer database to determine if the person posting the review received service on the date indicated and by the employee indicated in their review.

### Referrals

In one embodiment, the completion of a customer service review may prompt for a request for a customer referral by asking the customer to specifically broadcast their review to selected contacts via messaging, their social media page or a third-party reviewing website or application. The referral may be prompted only if the review is a positive review, such as when a customer rating of the employee exceeds a numerical score or has a keyword such as “excellent.” The referral may be directed specifically to the individual employee which provided the service instead of just the business/service provider in general in order to reward and promote the specific employee for their good customer service. Surveys and ratings may also be utilized to identify if a referral should be requested from the customer.

### System Workflow

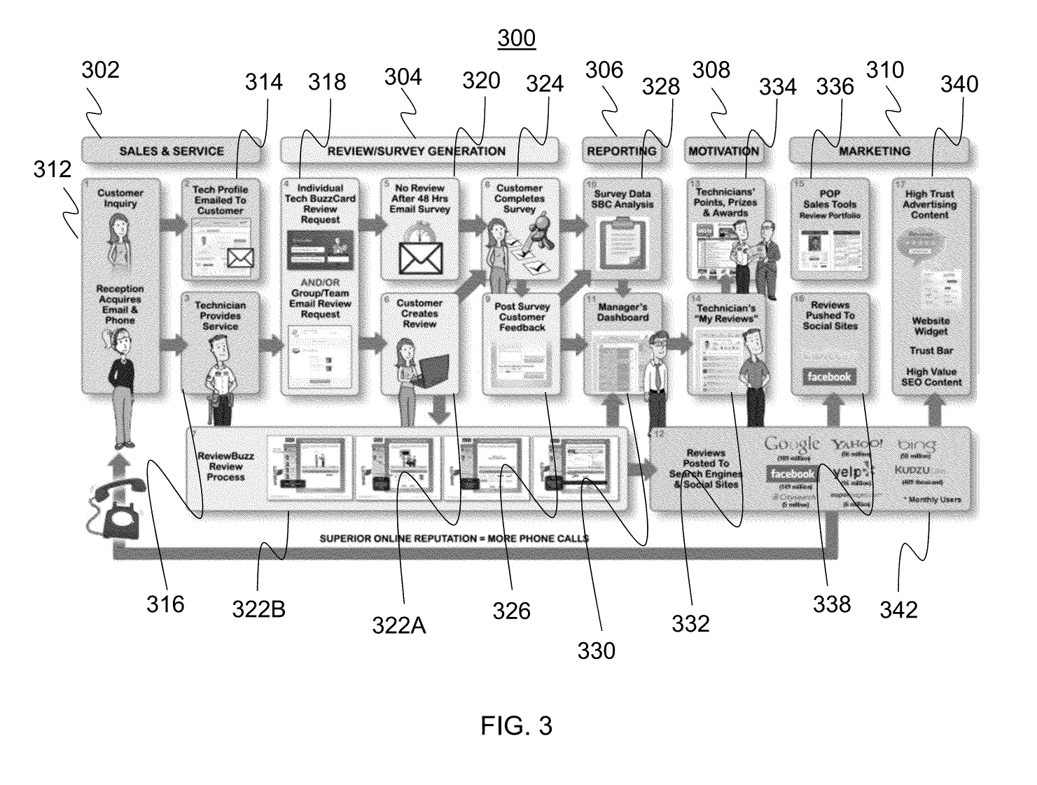

FIG. 3 illustrates one embodiment of a system and method for obtaining and utilizing online customer service reviews illustrating an overall workflow 300 of a sales and service process 302, a review generation process 304, a reporting and organization process 306, a motivation process 308 and a marketing process 310. This embodiment is directed to an employee of a direct service provider such as a plumber or electrician, although the system is equally applicable to any business with one or more employees which provide customer service and may receive customer service reviews. At the beginning of the sales and service process 302, a customer inquiry 312 is received from a customer who is interested in a business and inquires with that business for a quote to perform a particular service. The request may be made online through the business' website or via e-mail or phone, and the customer may then be provided with a quote and one or more review profiles 314 about one or more of the employees of the company that will be providing the service. The customer can then pick one or more of the employees that they would like to provide the service based on the review profiles of the employees.

The employee will then provide the requested service during a service appointment 316, after which time the review generation process 304 begins when the customer is asked by the employee or the employee's company to complete a review 318 by providing the customer with information on how to complete a review of the customer service they've received during the service appointment. The information may be provided to the customer with a simple information card, or by an email or text message to the customer, and may emphasize that the customer is being asked to review the performance of the individual employee who is providing service, in addition to or instead of a review of the business in general. If the customer does not complete a review within a certain amount of time 320, a reminder may be sent to the customer to follow up and request that the customer complete the review in order to increase the number of reviews obtained.

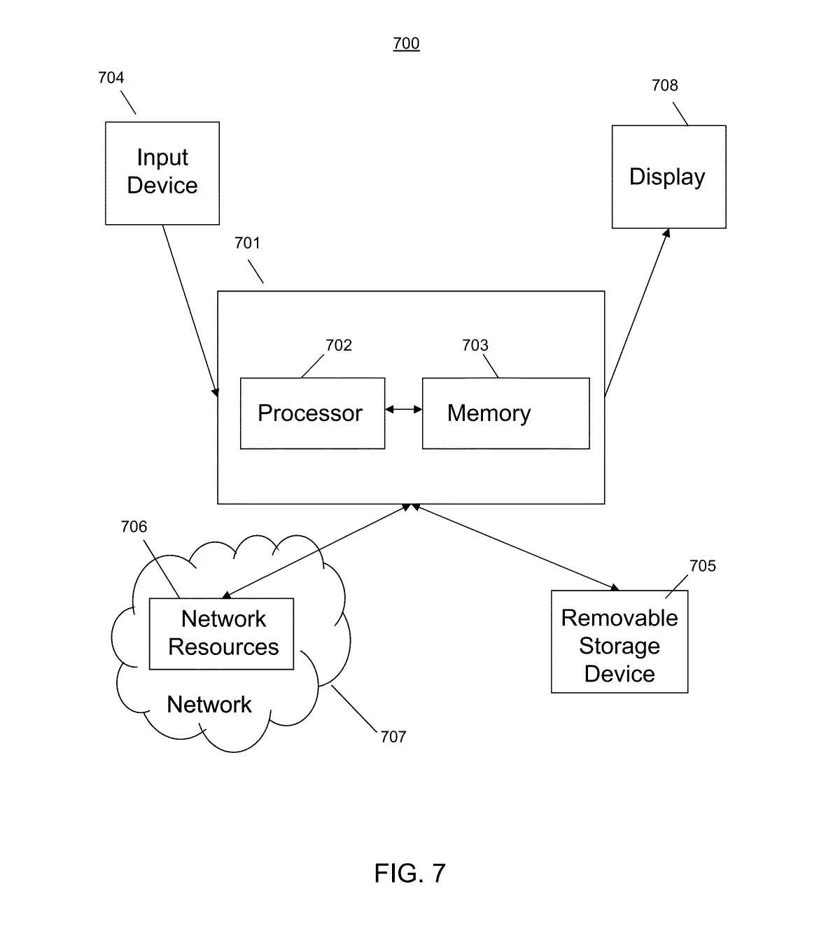

In one embodiment, the customer may complete the review 322A, a survey 324 or provide feedback 326 using a computing device with a display and an input, as is described further below in FIG. 7. The computing device may be the customer's home computer, laptop, tablet, smartphone or interactive television. The computing device may access a web-based application where the review can be completed or utilize software on the computer or smartphone which helps the user complete the review and then uploads the review to a central review server. The system may provide a proprietary user interface 322B for creating a customer service review, or the customer may also be able to complete the review using a third-party review service, after which the review may be obtained by the central review server and aggregated with other reviews. The system may therefore be configured to provide the user with the ability to create a review using the customer's preferred reviewing service, and then obtain that review afterwards for inclusion into the other reviews being collected at the central review server.

Once the review is completed, it may then be analyzed and classified in the reporting and organizing process 306 based on multiple factors, including the employee and business that it pertains to. If the review was a survey, the survey data may be evaluated using a net promoter score (NPS), SBC analysis or other method 328. The NPS evaluation may be computed for each employee and for the company overall. The reviews are therefore organized at the central review server in order to classify the reviews and generate summaries of the reviews in various formats, including a manager dashboard, administrator dashboard of reviews 330 of all employees and an employee review profile 332 which helps to summarize the review information.

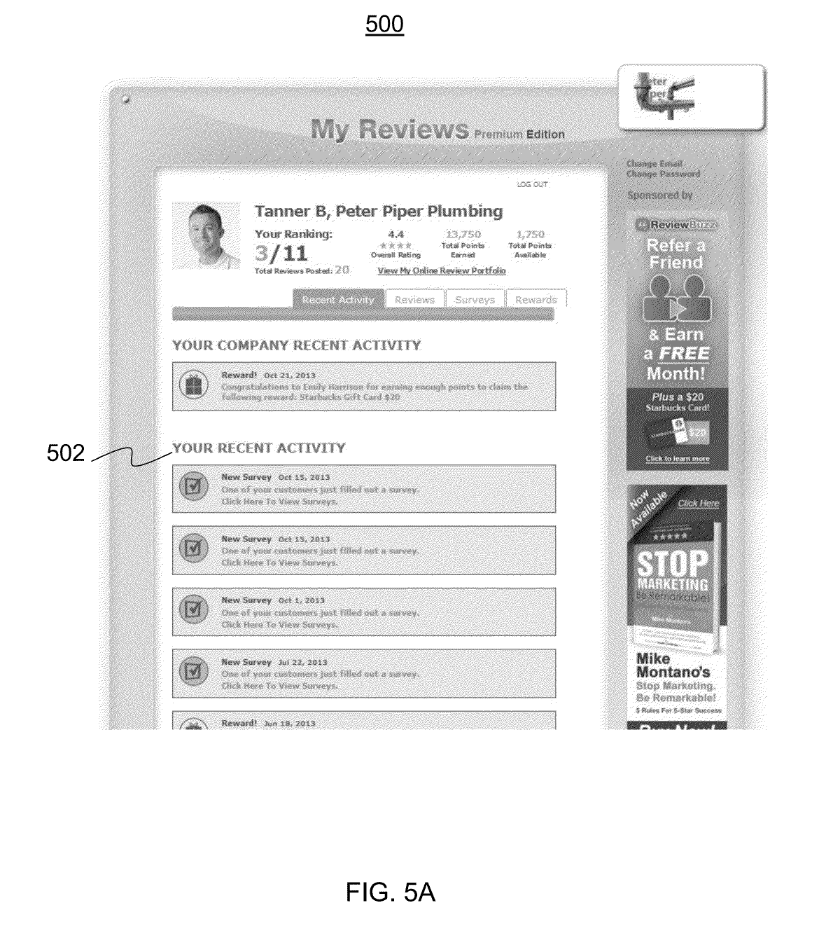

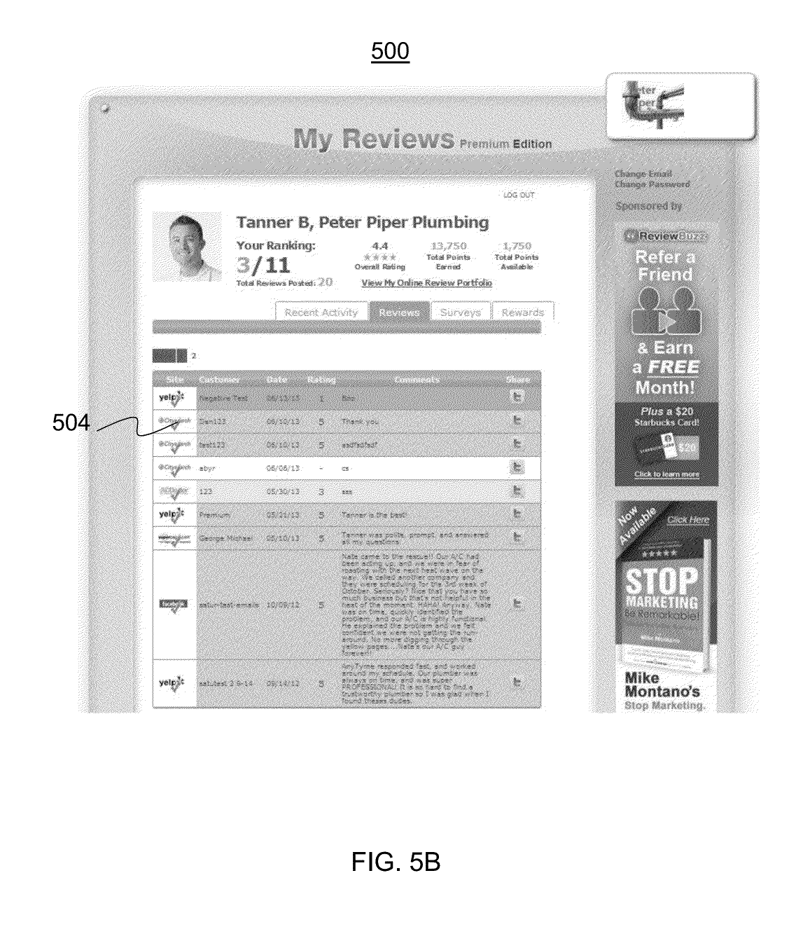

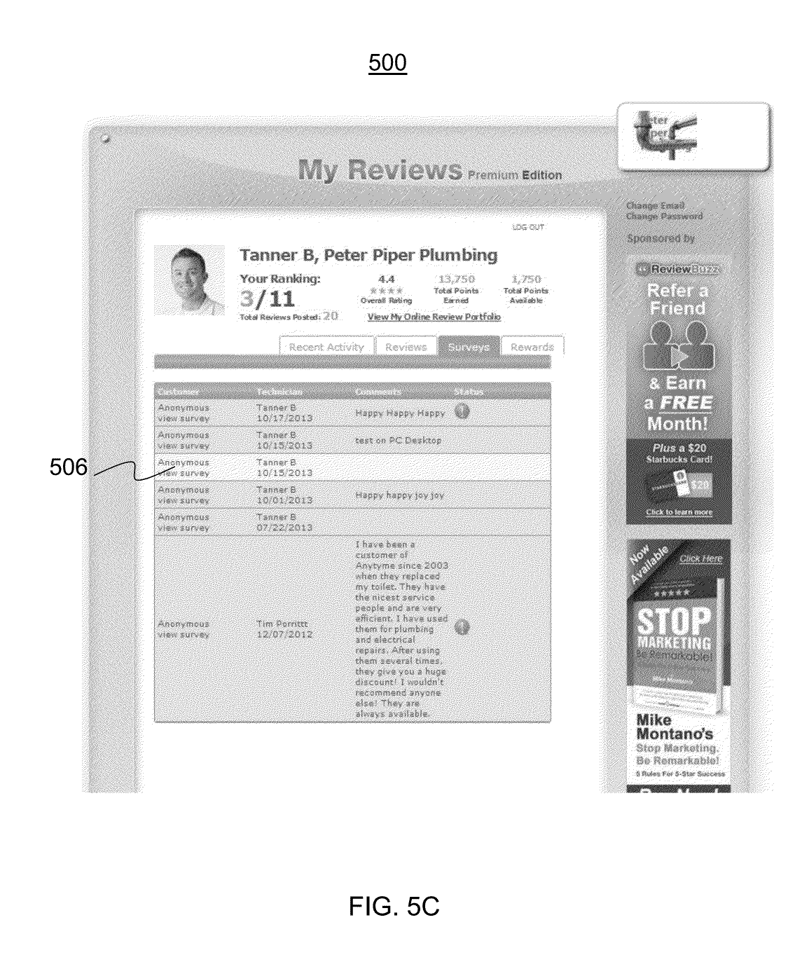

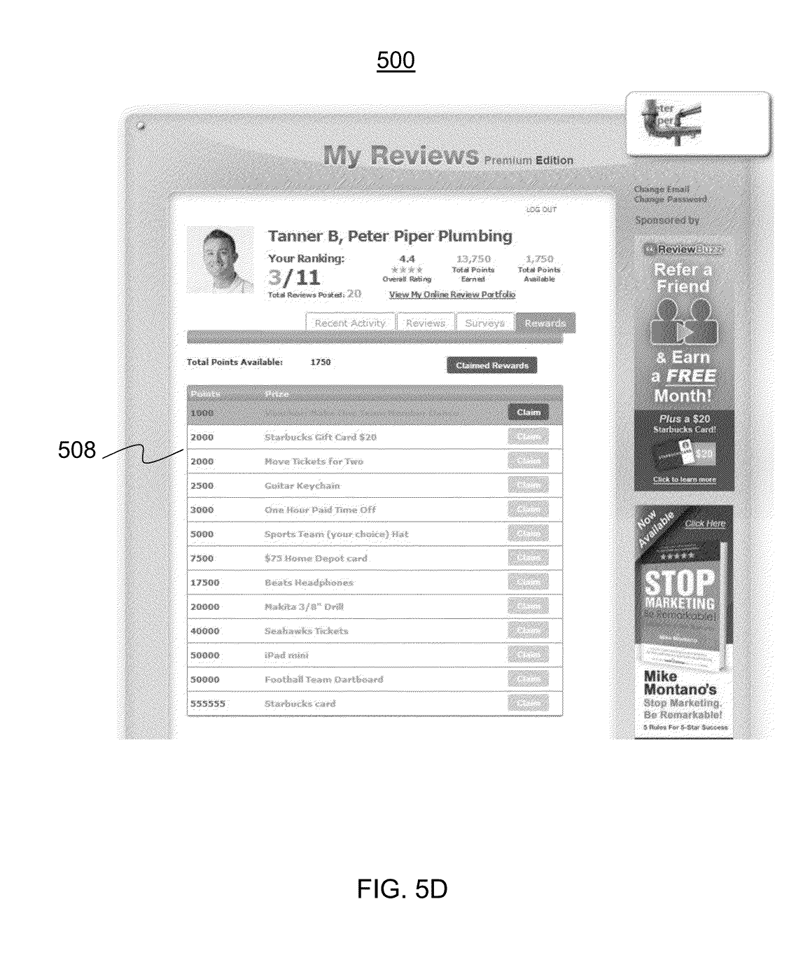

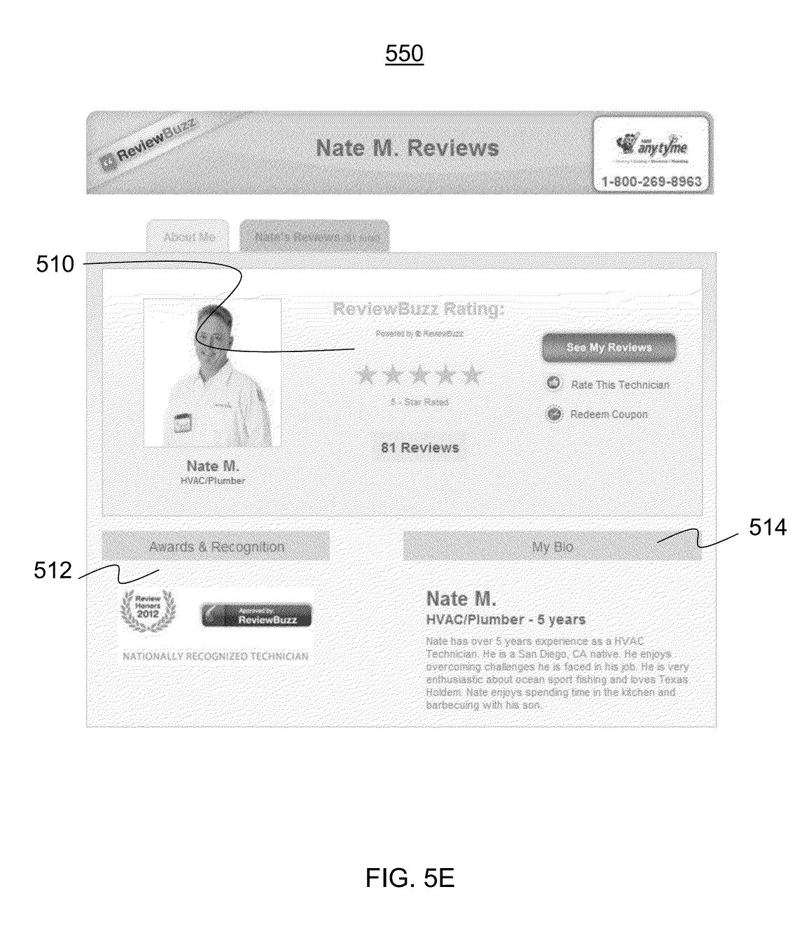

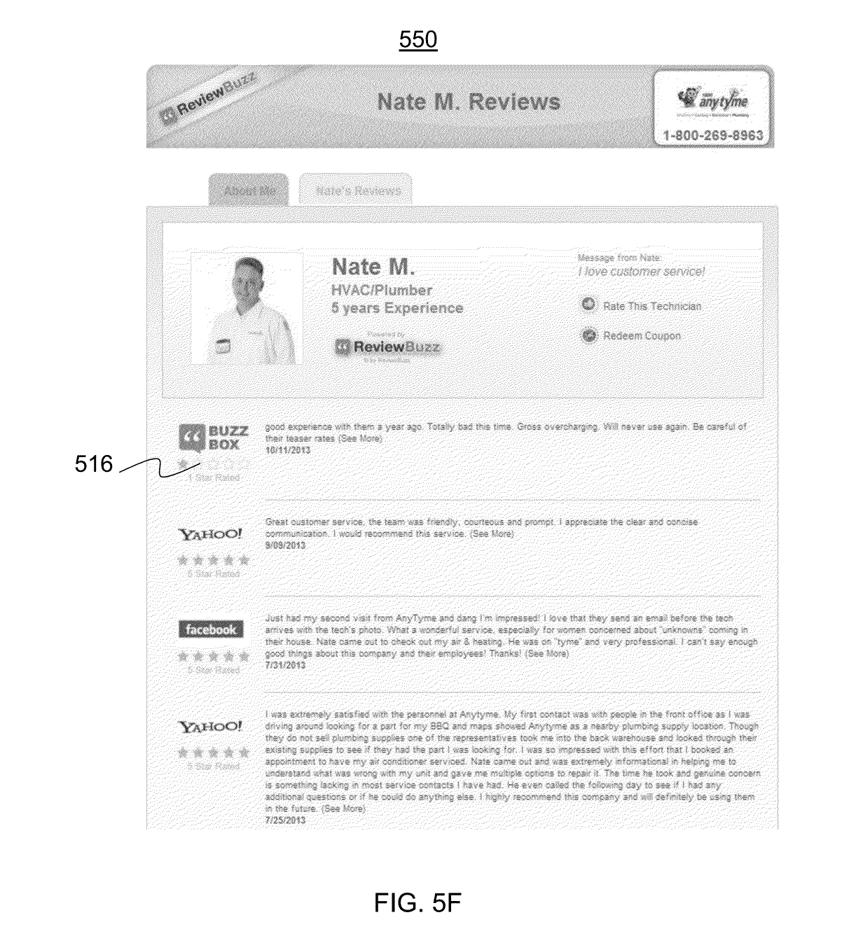

The reviews for a particular employee are aggregated and organized into an employee review profile 500 (see FIGS. 5A-5F), which is a graphical user interface (GUI) that may list notifications 502 of updates to the employee profile, employee rankings 504, one or more of the customer reviews 504 for that employee, employee surveys 506 along with additional information about the employee, such as the employee's training, experience, location, etc. The employee profile may also list rewards 508 the employee has earned, awards and other recognitions that the employee has received. The employee profile serves not only as a summary for the employee to see his or her performance, as illustrated in FIGS. 5A-5D, but also as a marketing tool that the business can use to market the service provided by that particular employee, as illustrated in FIGS. 5E-5F. FIG. 5E therefore illustrates a publicly-available employee profile 550 which displays an employee rating 510, awards 512 and a biography 514. In FIG. 5F, detailed third party reviews 516 are displayed so the customer can see reviews from multiple different sources. The employee review profile 332 is part of the motivation section 308, which is utilized along with incentives 334 such as points, prizes and awards to give the employee and incentive to provide better customer service.

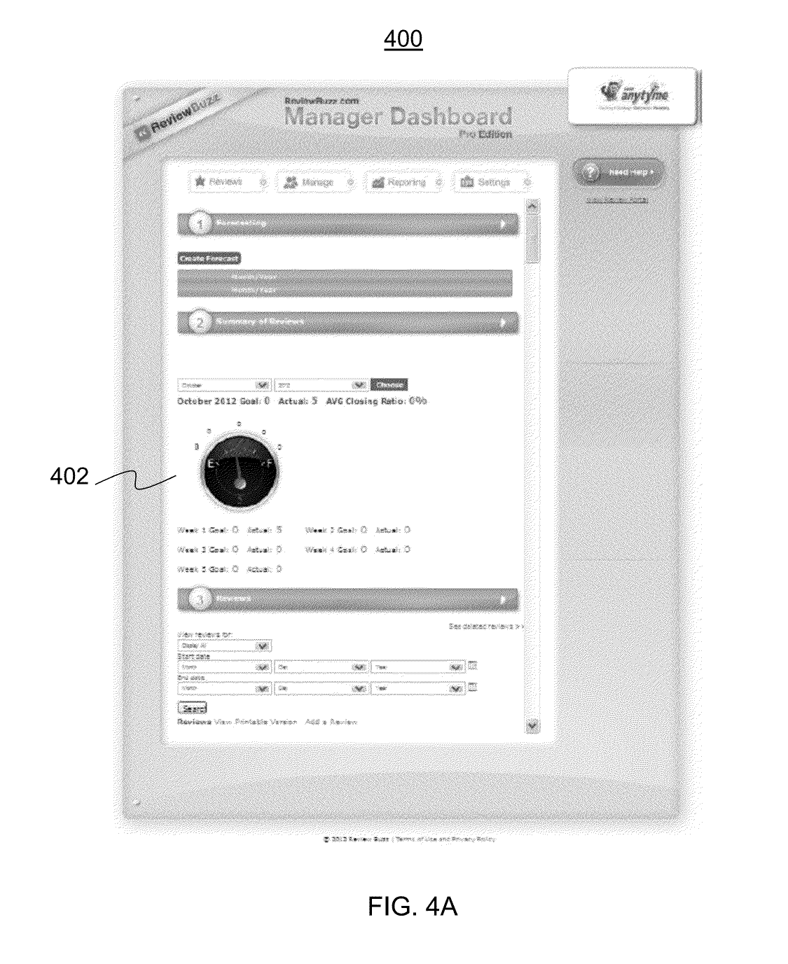

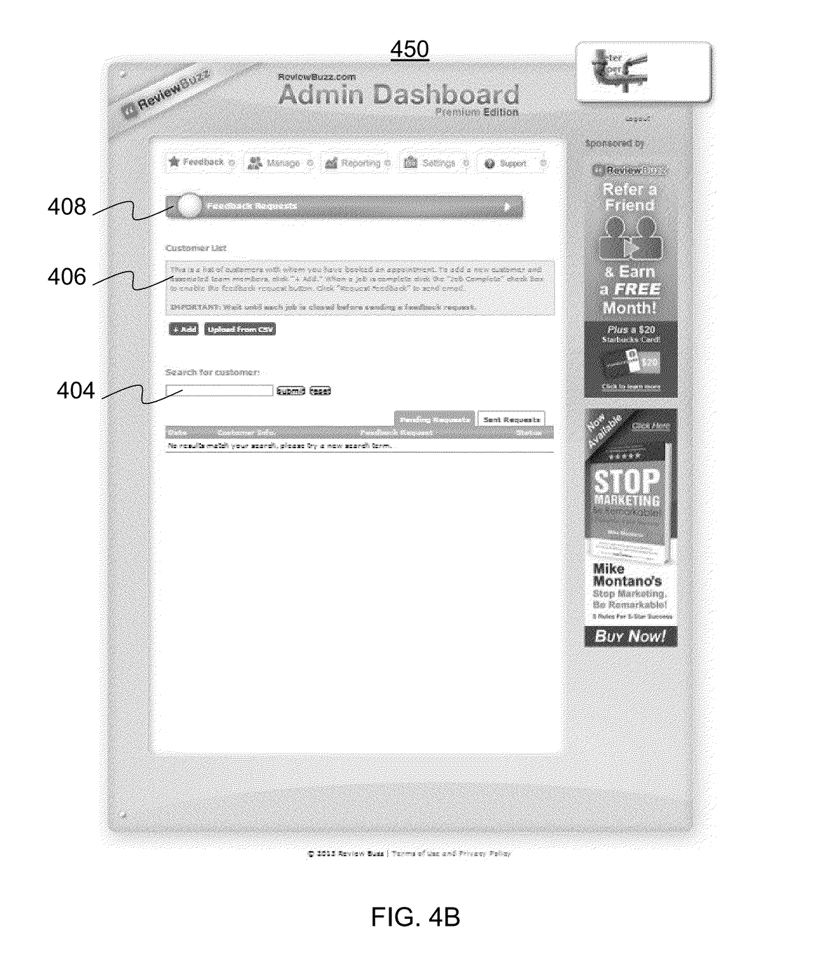

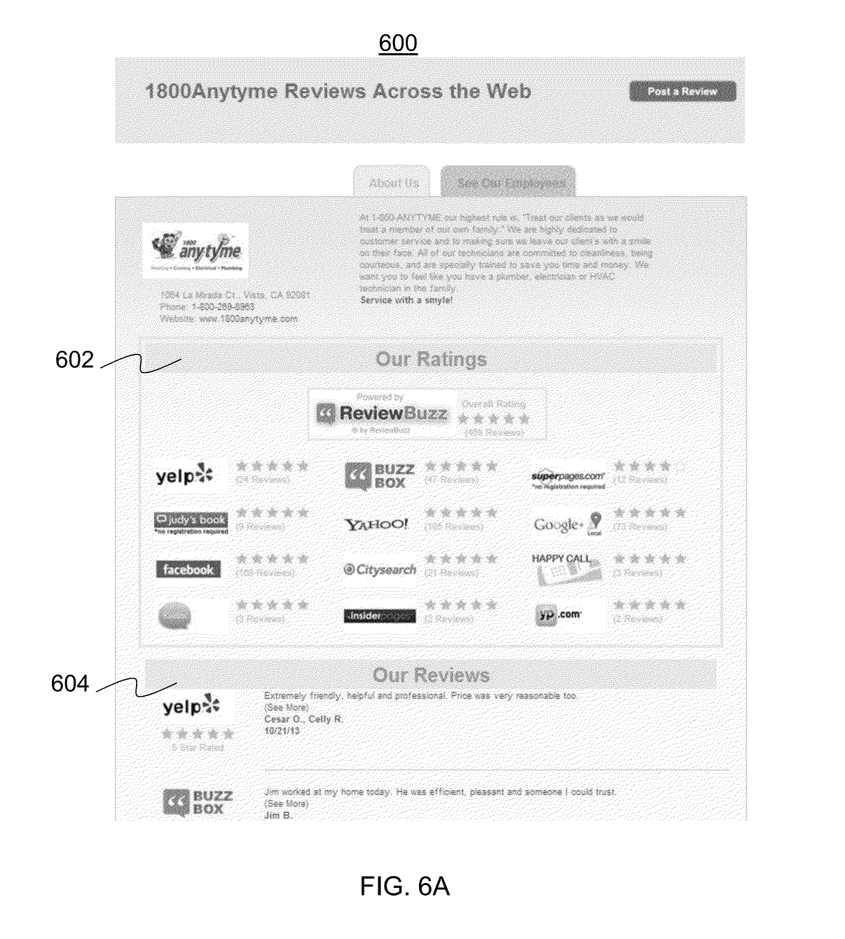

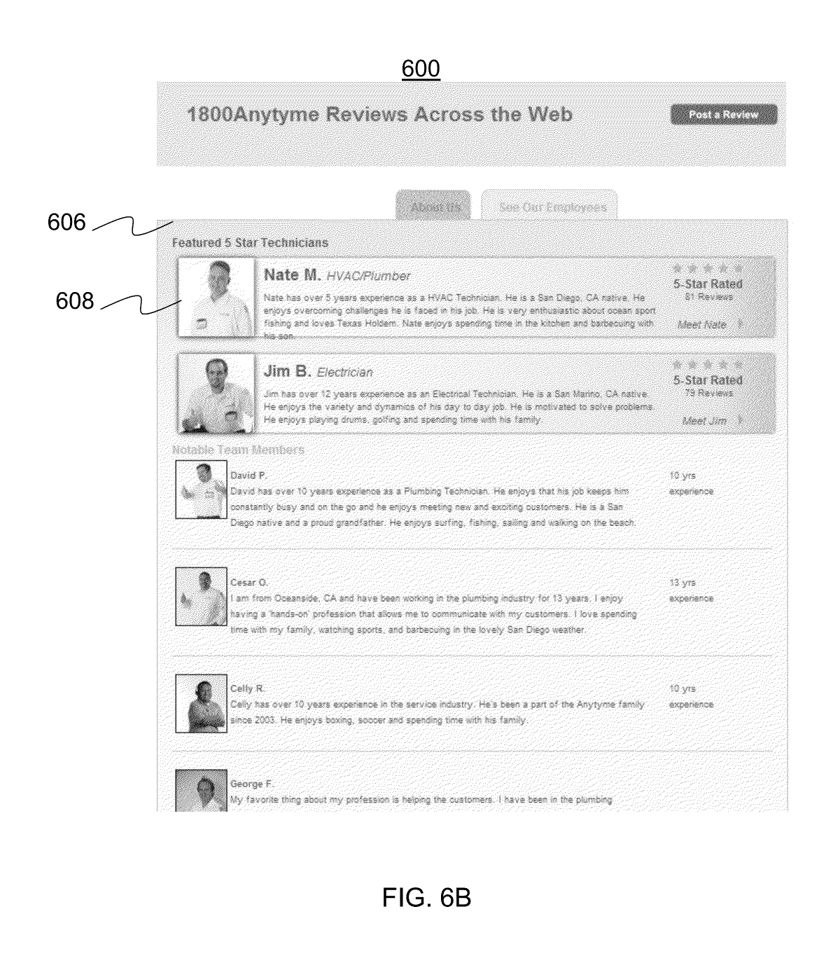

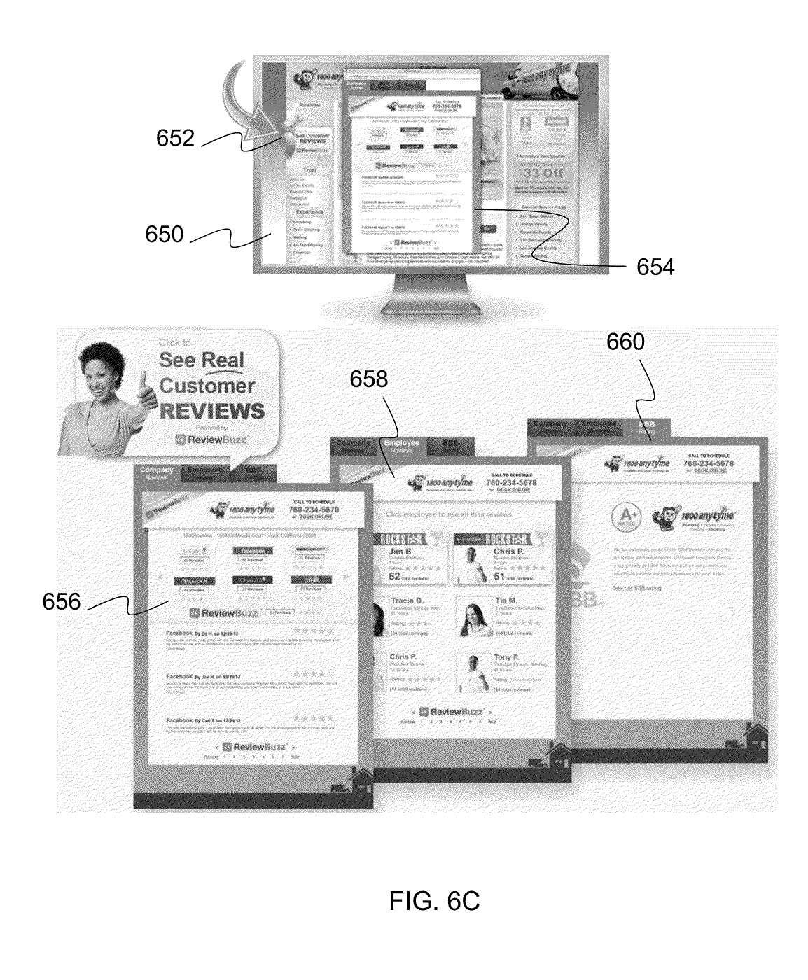

The review information may also be organized into the manager dashboard in FIG. 4A or the administrator dashboard in FIG. 4B. The manager dashboard 400 may provide additional analytics 402 of the reviews in order to help the employee and the business determine how their employees are performing, whether customers are completing reviews, whether their overall reputation is increasing or decreasing and other marketing strategies of how to broadcast the reviews to various destinations for advertising and marketing. The administrator dashboard 450 may provide options to search customers 404 or view customer lists 406, manage feedback requests sent to customers 408 and perform other administrative tasks. The business may then provide rewards and incentives to their employees 334 based on the reviews they are receiving, make decisions on salaries, pay and bonuses based on rankings of employee reviews, etc. A publicly-available business review profile 600 is illustrated in FIGS. 6A and 6B, showing overall ratings 602 for a plurality of review sites, specific reviews 604 and an employee profile page 606 which displays the ratings and reviews for each individual employee 608 than can then be selected to view the overall employee profile shown in FIGS. 5E and 5F.

Once the reviews are organized and classified, the individual employee review profiles 550, an overall business review profile 600 (illustrated in FIGS. 6A-6B) or even individual positive reviews may be broadcast to various destinations for use in marketing and advertising the business in the marketing process 310. This may include posting the reviews on the business' website 336, posting the reviews to a social media profile of the business 338 or the employee or placing online advertisements of the reviews on various websites 340 where the business advertises. In addition, the reviews can be broadcast to other third-party review services 342, such as search engines, directory search websites, yellow pages services, and other websites which display business information and collect customer service reviews. The reviews may be displayed on the business' website 650 using various user interfaces, such as a widget 652 which generates a review window 654, as illustrated in FIGS. 6C. If a customer is viewing the business website 650, the customer can select the widget 652 and have a review window 654 displayed with different tabs showing different review information. A company tab 656 shows the business review profile illustrated in FIG. 6A, while the employee tab 658 shows the employee profile page 606 shown in FIG. 6B. A third-party reviews tab 660 may show a third party official rating, such as that of an accredited reviewing organization.

In one embodiment, the reviews may be sent out via e-mail or other electronic messages to regular or potential customers. The review information may be organized in the form of an advertisement of a particular employee, of the business and the employee or of the business generally. As already mentioned above, the employee review profiles may also be used to distribute to potential customers interested in using the business, so that they can select a particular employee based on the employee's reviews.

### Individualized Employee Reviews

As described above, the customer service reviews are directed to an individual employee that is providing the service. Customers are more likely to complete a review of an individual person than a business, and are also more likely to report a positive review of an individual who provides good service rather than the general business. Therefore, by requesting and emphasizing that the review is for the individual employee, the customer is more likely to complete the review and to turn in positive reviews. The employees are encouraged to personally invite the customer to complete a review of them during the service appointment, which also increases the chance that the customer will complete a review and that a customer who receives a positive customer service experience will want to reward that employee with a positive review.

By providing individual reviews, the employees themselves are also more motivated to provide better customer service, as they know that their specific performance will be tied to their specific reviews. Employees that provide excellent customer service will therefore be much more likely to receive excellent reviews. Furthermore, by obtaining individualized customer reviews, the business can provide rewards, incentives, bonuses and raises to employees based on the reviews. The employer therefore has a better ability to evaluate and reward employees. Other motivational programs may be devised to motivate or reward an employee based on their individualized reviews, as would be apparent to one of skill in the art.

In addition, individual reviews of employees can be broadcast to potential customers, who will be more likely to use a particular business if they know the specific employee they have selected has a reputation for providing excellent customer service.

### Automated Reputation Management

The systems and methods described herein provide a complete customer service review process from start to finish that requires minimal involvement on the part of the business and the employee. The service is configured to handle the review requests to the customers, receive and manage the process of obtaining the customer reviews, aggregate and organize the review information, create review profiles and dashboard interfaces for the employees and businesses, and broadcast the review information to websites, social media and messaging in order to advertise and market the business' and employees' reputations.

### Mobile Platform for Reviews

In one embodiment, the systems and methods for requesting, receiving, organizing and broadcasting customer service reviews may be incorporated onto a mobile platform for use on a portable electronic device. The mobile review platform may be a standalone system that is implemented through a software application running on the mobile device and interfacing with the central review server, or the mobile review platform may be integrated with another mobile platform related to the business. For example, a business may provide a mobile application to smartphone or tablet users that provides information on the customer's accounts, allows the customer to shop for items, request services, etc. The review platform may therefore be integrated with that application interface so that whenever a customer makes a purchase or interfaces with the application to request a service appointment, the opportunity to create a customer review is provided.

In one embodiment, the mobile review platform may be integrated with a mobile payment system, so that when a customer makes a payment for a product or service, the opportunity to create a customer service review is immediately provided to the customer upon completion of the payment. This will increase the likelihood that the customer will complete a review, since the review will be requested as soon as the payment is complete.

In one embodiment, having the review tied to the payment process also provides a built-in authentication of the review that ensures that the person completing the review is the person who actually received the service from the employee. Reviews which can be confirmed to have been created by an actual customer who received service from a specific employee are much more valuable to a potential customer reading the review and the employer and employee who received the review. As many third-party review services have no way of verifying that the person completing the review actually interacted with the company or even a specific employee within the company, the integration of reviews with mobile payment eliminates the uncertainty that is found in customer reviews. This authentication feature therefore provides an automatic verification of the review since it is tied to the mobile payment process, and may even be used to filter reviews based on whether they have been authenticated or not. A company or a customer may be allowed to filter the reviews based on whether they have been verified in order to see reviews that they know have been tied to a specific customer service experience or product purchase.

### Computer-Implemented Embodiment

FIG. 7 is a block diagram illustrating an example wired or wireless system that may be used in connection with the various embodiments described herein. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A method of authenticating online customer service reviews, comprising:
receiving payment information from a customer for a service by a service provider;
prompting the customer to complete a customer service review upon receipt of the payment information;
receiving a customer service review from the customer in response to the prompt; and
authenticating the customer service review as being created by the customer which received the service.

2. The method of claim 1, wherein the payment information and customer service review are received from an application running on a mobile device.

3. The method of claim 1, wherein the payment information is received from an employee electronic device and the customer service review is received from an application running on a mobile device.

4. The method of claim 1, wherein the customer service review is received from a third-party source.

5. The method of claim 1, wherein the customer service review is authenticated by matching the payment information from the customer with customer information stored by the service provider.

6. The method of claim 1, wherein the customer service review is authenticated by matching the payment information from the customer with information in the customer service review.

7. The method of claim 6, wherein the information in the customer service review which is matched with the payment information includes at least one of: a customer name, a date of performance of the service, a location of the service and a name of an employee of the service provider which provided the service.

8. The method of claim 1, wherein the customer service review is directed to an employee who performed the service.

9. The method of claim 1, further comprising displaying the authenticated review on a website with an indication of the authenticity of the customer service review.

10. A method of authenticating online customer service reviews, comprising:
receiving at least one customer service review relating to a service performed for a customer by a service provider;
selecting at least one unique customer identifier for authenticating the at least one customer service review;
determining whether the at least one unique customer identifier matches information about the service performed for the customer by the service provider; and
authenticating the at least one customer service review as being created by the customer which received the service if the at least one unique customer identifier matches the information about the service performed for the customer by the service provider.

11. The method of claim 10, wherein the unique customer identifier is selected from at least one of: a customer name, a customer address, a credit card number, a payment amount for the service, a customer biometric indicator, a customer gesture, a customer passcode, a location of a customer mobile device in relation to an address where the service was performed and a location of a customer mobile device in relation to a location of an employee mobile device of an employee that performed the service.

12. The method of claim 10, wherein the unique identifier and customer service review are received from an application running on a mobile device.

13. The method of claim 10, wherein the unique identifier and customer service review are received from different sources.

14. The method of claim 10, wherein the customer service review is received from a third-party review source.

15. The method of claim 10, wherein the customer service review is directed to an employee who performed the service.

16. The method of claim 10, further comprising displaying the authenticated review on a website with an indication of the authenticity of the customer service review.

17. The method of claim 10, further comprising displaying a customer service review which has not been authenticated with an indication of the lack of authenticity of the customer service review.

18. The method of claim 10, further comprising prompting the customer for a referral if the customer service review is a positive review.
